(19) United States
(12) Patent Application Publication
(10) Pub. No.: US 2006/0275071 A1
(43) Pub. Date: Dec. 7, 2006

(54) Printer with piercing device

(76) Inventors: Charles Evans, Corvallis, OR (US); Paul Woods, Corvallis, OR (US); Pamela Voss, Corvallis, OR (US)

Correspondence Address: BRINKS HOFER GILSON & LIONE/MARVELL, P.O. BOX 10395, CHICAGO, IL, 60610, US

(21) Appl. No.: 11/144,215

(22) Filed: Jun. 2, 2005

(51) Int. Cl. B41J 11/66

(52) U.S. Cl. 400/621

(57) ABSTRACT

A printer includes a controller, a printhead operable, in response to at least a first signal received from the controller, to render an image on a print medium, and a piercing device operable, in response to at least a second signal received from the controller, to produce a predetermined pattern of piercings in the print medium.

### BACKGROUND

A user of a printer, in many cases, desires that portions of a printed document be physically detachable from other portions of the same document. For example, a user using a personal computer (PC) may desire to print out documents embodying checks, bills or other items that the user wishes to detach. In the case of checks or bills, the user must purchase and use paper that has been perforated prior to being fed into a printer. This pre-perforated paper is often significantly more expensive than regular printer paper. Otherwise, the user must first print the document, remove the document from the printer, and then employ a cutting device, such as scissors, to detach the item from the remainder of the document. This latter approach can be unduly time-consuming and fatiguing to the user.

### SUMMARY

An embodiment of the present invention provides a printer including a controller, a printhead operable, in response to at least a first signal received from the controller, to render an image on a print medium, and a piercing device operable, in response to at least a second signal received from the controller, to produce a predetermined pattern of piercings in the print medium.

By including the piercing device in the printer, a user, in a customized fashion, can perforate or otherwise cut a document upon printing without having to pre-perforate or buy pre-perforated the paper on which the document is printed.

### BRIEF DESCRIPTION OF THE DRAWINGS

FIG. 1 is a schematic view of a system including a printer according to an embodiment of the invention;

FIG. 2 is a diagram of components of the printer illustrated in FIG. 1;

FIGS. 3A-3B are diagrams of alternative embodiments of the invention; and

FIGS. 4A-4B are diagrams of an alternative embodiment of the invention.

### DETAILED DESCRIPTION

The following discussion is presented to enable a person skilled in the art to make and use the invention. Various modifications to the preferred embodiment will be readily apparent to those skilled in the art, and the generic principles herein may be applied to other embodiments and applications without departing from the spirit and scope of the present invention as defined by the appended claims. Thus, the present invention is not intended to be limited to the embodiment shown, but is to be accorded the widest scope consistent with the principles and features disclosed herein.

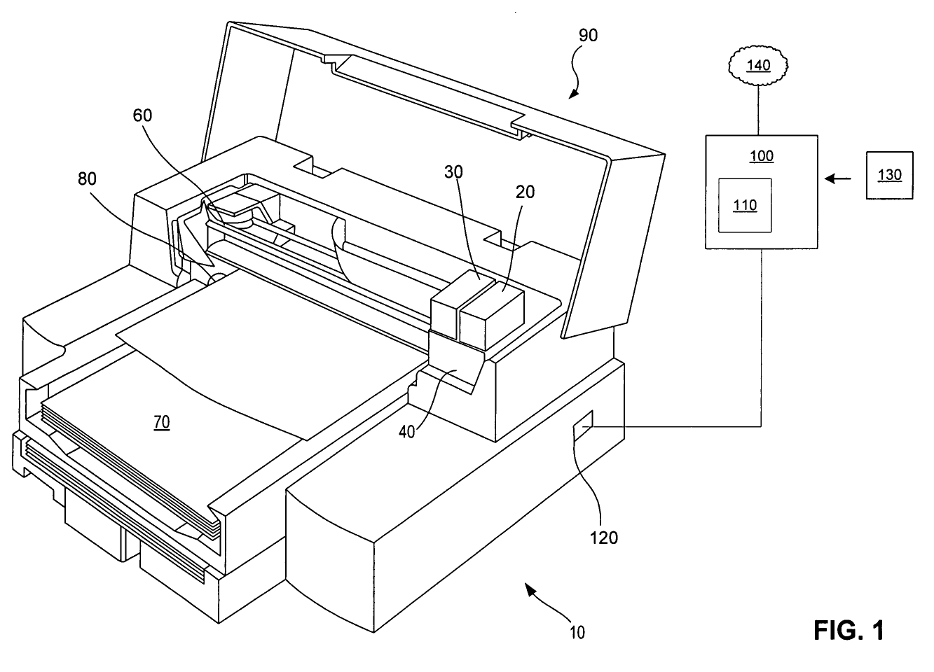

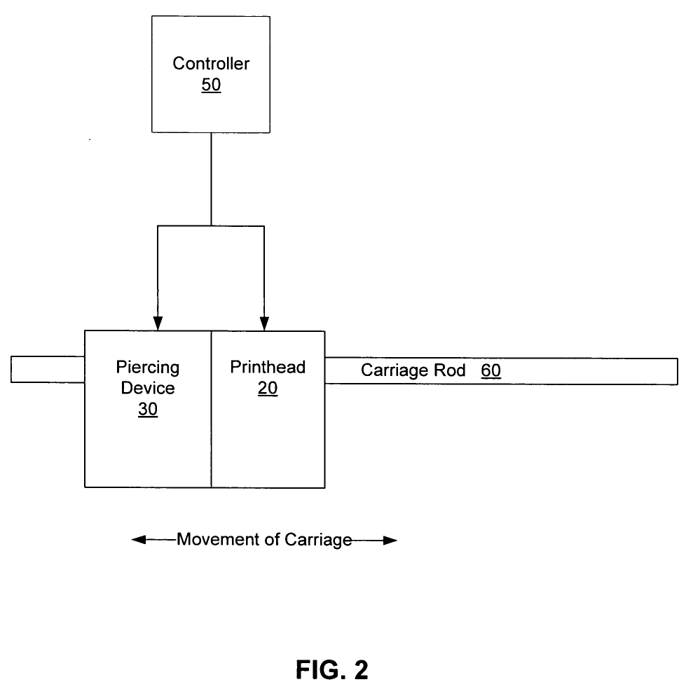

FIGS. 1 and 2 show an inkjet printer 10 according to an embodiment of the invention. The inkjet printer 10 includes a printhead 20 and a piercing device 30 mounted within a carriage 40, all of which are controlled by a controller 50 (FIG. 2). The carriage 40 is mounted to a carriage rod 60 that allows the carriage to travel back and forth across a dimension, such as the width, of a print medium 70, such as paper. A conventional roller 80 moves the print medium 70 relative to the carriage 40 in a plane perpendicular to the plane of travel of the carriage along the rod 60. The printhead 20 includes an array of tiny nozzles (not shown) that emits droplets of ink to render images and text on the print medium 70. The piercing device 30 is configured to contact and pierce or otherwise cut the print medium 70. Each component of the printer 10, as well as the portion(s) of the print medium 70 pierced and/or to which ink is applied, may be disposed within a housing 90.

Referring to FIG. 1, the printer 10 may be coupled to an electronic device, such as a PC 100, having a computer-readable medium 110, such as a hard disk. The printer 10 may be coupled to the PC 100 via a data port 120, such as a universal-serial-bus or other port. In an embodiment, the PC 100 executes conventional software applications, such as word-processing programs, imaging programs and/or a printer driver, stored in the medium 110 and operable to deliver to the printer 10 a document or image for the printer to print. The PC 100 may further execute, in conjunction or association with such applications, a piercing-placement software application stored in the medium 110 and enabling a user of the PC to define, using a mouse, keyboard and/or other conventional input device (not shown), a pattern of one or more pixel locations at which, upon printing of a document or image, the user wishes the document or image to be pierced or otherwise cut. The PC 100 may subsequently transmit to the printer 10 one or more signals characterizing the document or image, as well as the pattern. The piercing-placement application may be received by and installed to the PC 100 from a portable computer-readable medium 130, such as a compact disk, or over a local-area or wide-area network 140.

In operation, as the printhead 20 is moved across the print medium 70 and the print medium is moved relative to the carriage 40, the controller 50 activates the printhead to emit droplets of ink at precise locations corresponding to a pattern of pixels associated with a document or image received from the PC 100. Similarly, as the piercing device 30 is moved across or otherwise with respect to the print medium 70, the controller 50 activates the piercing device 30 to pierce the print medium at precise locations corresponding to the piercing locations associated with the pattern defined by the user. As such, because the piercing device 30 is movable, via the carriage 40, along a first dimension (e.g., the width) of the print medium 70 and the roller 80 is operable to move the print medium relative to the piercing device along a second dimension (e.g., the length) of the print medium, a pattern of perforations in two dimensions of the print medium may be achieved. Alternatively, the carriage 40 and, thus, the piercing device 30 may be movable in two dimension relative to the print medium 70 to provide a two-dimensional perforation pattern.

The printhead 20 and piercing device 30 may be simultaneously operational. That is, the printer 10 may be configured to concurrently print on and pierce the print medium 70. Alternatively, the printer 10 may be configured such that the printhead 20 applies ink to a swath of the print medium 70, after which the piercing device 30 is deployed to pierce one or more locations along or near the same swath. In the latter case, the ink may be allowed to dry prior to piercing of the print medium 70 to ensure that the ink does not seep through the piercing to other components of the printer 10.

In an embodiment, the piercing device 30 is not permanently attached to, but, rather, is retrievable by, the carriage 40. For example, the piercing device 30 may be parked in a “home” position on, for example, an end of the rod 60. Accordingly, when, for example, the printhead 20 is employed to print an image on a portion of the print medium 70 not requiring piercing, the carriage 40 does not transport the piercing device 30. Upon receiving an indication from the controller 50 that the print medium 70 is to be pierced, the carriage 40 is operable to move along the carriage rod 60 to the home position of the piercing device 30, couple itself to the piercing device using, for example, a conventional latching device, and move the piercing device to the location of the print medium 70 to be pierced.

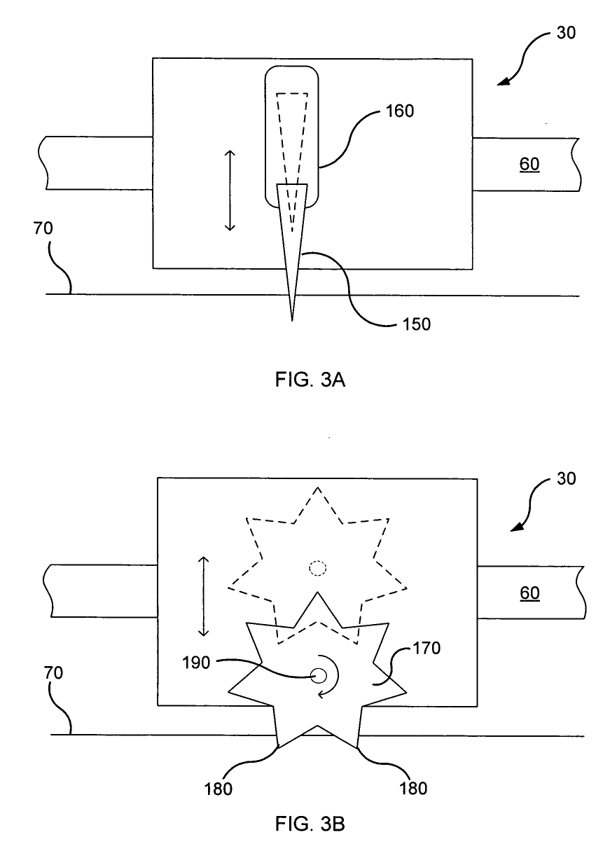

FIGS. 3A and 3B illustrate alternative embodiments of the piercing device 30. For clarity of illustration, the carriage 40 is omitted from FIGS. 3A and 3B. The embodiment illustrated in FIG. 3A includes a needle 150 attached to an actuator 160 operable to cause translational movement of the needle. The actuator 160 may be any appropriate conventional device, such as, for example, a solenoid, operable to raise and lower the needle 150. As such, the actuator 160, in response to a signal from the controller 50, functions to move the needle 150 from a home position (indicated by dashed lines) to a deployed position in which the needle pierces the print medium 70 in a predetermined location thereof, and subsequently retract the needle to the home position. Alternatively, the piercing device 30 may include a blade attached to the actuator 160. Consequently, the piercing device 30 may be used to shear a portion of the print medium 70 by moving the blade into the deployed position and moving the piercing device along the rod 60.

Referring to FIG. 3B, the piercing device 30 may include a rotatable member, such as a perforating wheel 170, having one or more blades 180 disposed along the perimeter of the wheel. In a manner similar to that of the needle 150 of FIG. 3A, the wheel 170 can be translated by an actuator (not shown) back and forth between a home position (indicated by dashed lines) and deployed position in which the blades 180 engage the print medium 70. The wheel 170 is further rotatable about an axis 190. As such, upon actuating the wheel 170 to the deployed position, the piercing device 30 may be moved along the rod 60, thereby rotating the wheel about the axis 190 and creating a series of perforations in the print medium 70.

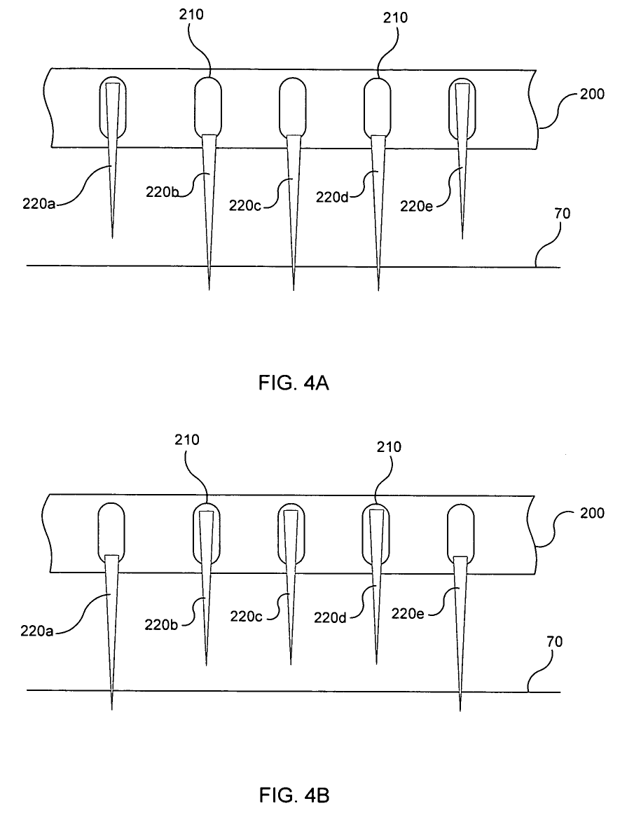

FIGS. 4A and 4B illustrate an additional alternative embodiment of the invention. In the illustrated embodiment, the printer 10 includes a piercing platform 200 disposed within the housing 90. The piercing platform 200 includes a plurality of actuators 210 to which are attached a corresponding plurality of piercing devices, such as needles 220a-220e. The piercing platform 200 and needles 220 are disposed within the housing 90 in a manner allowing the needles to engage the print medium 70 across at least a portion of a dimension (e.g., the width) of the print medium. For example, the piercing platform 200 may be positioned in parallel with the rod 60.

Referring to FIGS. 1 and 4A, the roller 80 has moved the print medium 70 into a first position relative to the piercing platform 200. In response to a signal from the controller 50 (FIG. 2), a first set of the needles 220, including needles 220b-220d, is actuated to pierce the print medium 70 at precise locations corresponding to a first set of piercing locations associated with a pattern defined by the user.

Referring to FIG. 4B, the roller 80 has moved the print medium 70 into a second position relative to the piercing platform 200. In response to a signal from the controller 50, a second set of the needles 220, including needles 220a and 220e, is actuated to pierce the print medium 70 at precise locations corresponding to a second set of piercing locations associated with the pattern defined by the user. In this manner, for each incremental advancement of the print medium 70 by the roller 80, a specific set of needles 220 may be actuated to pierce the print medium to provide a pattern of perforations in two dimensions of the print medium. Of course, if desired all of the needles 220 may be simultaneously actuated to perforate the print medium 70 across, for example, its entire width.

While embodiments of the present invention have been discussed herein in the context of an inkjet printer, the present invention is not to be construed as limited to implementation in an inkjet printer. For example, embodiments of the present invention may be implemented in other types of printers such as, for example, laser printers, dye-sublimation printers and light jet printers. As such, the printhead 20 may be a type of ink-application device, such as a laser-printing assembly, other than an inkjet printhead. Additionally, while the printer 10 has been described herein as including the piercing device 30, the piercing device may be regarded as a separate module that is attachable to the printer and functions in the manner described. Accordingly, the piercing device 30, along with one or more of the computer-readable media discussed with reference to FIG. 1, may be considered a system enabling the printer 10 to perform the functions described herein.

Additionally, although embodiments of the printer 10 described herein may allude, for exemplary purposes, to certain types of computer-readable media that the printer includes or with which the printer interacts, it should be recognized that such embodiments may include or interact with a variety of computer-readable media.

Computer-readable media can be any available media that can be included and/or accessed by the printer 10 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, DVD or other optical disk storage, magnetic cassettes, magnetic tape, magnetic disk storage or other magnetic storage devices, or any other medium that can be used to store information and that can be included and/or accessed by the printer 10. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

From the foregoing it will be appreciated that, although specific embodiments of the invention have been described herein for purposes of illustration, various modifications may be made without deviating from the spirit and scope of the invention.

What is claimed is:

1. A printer, comprising:
a controller;
a printhead operable, in response to at least a first signal received from the controller, to render an image on a print medium; and
a piercing device operable, in response to at least a second signal received from the controller, to produce a predetermined pattern of piercings in the print medium.

2. The printer of claim 1 wherein the printhead comprises an inkjet printhead.

3. The printer of claim 1 wherein the printhead comprises a laser-printing assembly.

4. The printer of claim 1 wherein the piercing device comprises a blade.

5. The printer of claim 1 wherein the piercing device comprises a needle.

6. The printer of claim 1 wherein the piercing device comprises a plurality of needles.

7. The printer of claim 6, further comprising a roller coupled to the printhead and operable to move the print medium into a first position, wherein a first predetermined set of the plurality of needles is operable to pierce the print medium when the print medium moves into the first position.

8. The printer of claim 7 wherein:
the roller is further operable to move the print medium into a second position; and
a second predetermined set of the plurality of needles is operable to pierce the print medium when the print medium moves into the second position.

9. The printer of claim 1 wherein the piercing device comprises a rotatable member operable to contact the print medium.

10. The printer of claim 1, further comprising a carriage operable to move the piercing device into a position to pierce the print medium.

11. The printer of claim 10 wherein the piercing device is retrievable by the carriage.

12. The printer of claim 1 wherein the pattern comprises at least three piercings.

13. The printer of claim 1, further comprising a data port coupled to the controller and operable to receive a third signal characterizing the pattern.

14. A system, comprising:
a piercing device coupleable to a printer and operable to pierce at least one predetermined portion of a print medium; and
a computer-readable medium having stored therein executable instructions that, when executed by a processor, are operable to cause the processor to:
generate a signal operable to cause the piercing device to produce a predetermined pattern of piercings in the print medium.

15. The system of claim 14 wherein the instructions are further operable to cause the processor to enable a user to define the pattern.

16. The system of claim 14 wherein the printer comprises an inkjet printer.

17. The system of claim 14 wherein the computer-readable medium comprises a modulated carrier signal.

18. A method, comprising:
rendering an image on a first portion of a print medium, the first portion at least partially disposed within a housing; and
producing a predetermined pattern of piercings in a second portion of the print medium, the second portion at least partially disposed within the housing.

19. The method of claim 18, further comprising receiving from an electronic device a signal operable to characterize the predetermined pattern.

20. The method of claim 18 wherein the rendering and producing occur substantially concurrently.
